(19) United States
(12) Patent Application Publication
(10) Pub. No.: US 2005/0225974 A1
(43) Pub. Date: Oct. 13, 2005

(54) FLUORESCENT BULB CONNECTOR WITH A SPRING BOARD NIB

(75) Inventors: Dallas Buchanan, Evanston, IL (US); Don Horner, Monroeville, NJ (US); Gary Jackere, Cherry Hill, NJ (US); Mario Gallo, Indian Creek, IL (US); Gerry Malone, Hellertown, PA (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: A.L.P. LIGHTING & CEILING PRODUCTS, INC., Niles, IL (US)

(21) Appl. No.: 10/905,785

(22) Filed: Jan. 20, 2005

Related U.S. Application Data
(60) Provisional application No. 60/557,824, filed on Mar. 30, 2004.

(51) Int. Cl. F21S 4/00

(52) U.S. Cl. 362/217; 362/260; 362/285

(57) ABSTRACT

An socket is provided with a flexible nib that is able to be received by a mounting plate with an aperture. The socket is easily removed and secured to the mounting plate and will also be received in a mounting plate without an aperture.

### CROSS REFERENCE TO RELATED APPLICATIONS

This application claims benefit to U.S. Provisional Application 60/557,824 filed on Mar. 30, 2004.

### FIELD OF THE INVENTION

The present invention relates to a connector placed in a bulb socket defined by a lighting fixture for effectively receiving a fluorescent bulb.

### BACKGROUND OF THE INVENTION

In the United States, fluorescent light bulbs are provided, in 18 inch, 2 to 6 foot and 8 foot lengths, with the popular lengths being two and four foot lengths. The diameter of the bulb is commercially referred to as a T portion, with the portion being defined in increments of 8^{th} of an inch. A typical United States commercial light bulb will have a diameter that is identified as “T8”, i.e., one inch in diameter.

The bulbs are received in sockets defined by fluorescent lighting fixtures. The sockets, for various reasons, are removably secured to the lighting fixtures. This is done to allow the sockets to be replaced in case an old socket is damaged or burnt out. The sockets are secured to mounting plates fixed to the lighting fixtures. The mounting plates includes notches to receive the sockets. In addition some mounting plates may additional include an aperture positioned in front of the notch to accommodate a protruding rigid nib on the socket. The problem with the prior art is if the mounting plate does not include an aperture to accommodate the protruding nib the socket will not properly align and fit into the mounting plate. This problem is solved by the present invention.

### SUMMARY OF THE INVENTION

In accordance with the present invention a socket for mounting to a lighting fixture is provided with a nib. The nib is attached to a flexible arm such that the socket is easier to remove from the mounting plate defined by the lighting fixture and the socket can be used with mounting plates that do not accommodate for the nib.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a side view of a mounting profile of a fluorescent lamp fixture;

FIG. 2a is a front view of a socket in accordance with the present invention;

FIG. 2b is a side view of the socket from FIG. 2a;

FIG. 2c is a top view of the socket from FIG. 2a;

FIG. 3a is a side view of the socket from FIG. 2a mounted to a first mounting plate that does not include an aperture for a spring nib defined on the socket;

FIG. 3b is a top view illustrating the socket shown in FIG. 3a;

FIG. 4a is a side view of the socket from FIG. 2a mounted to a second mounting plate that includes an aperture for the spring nib; and

FIG. 4b is a top view illustrating the socket shown in FIG. 4a.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

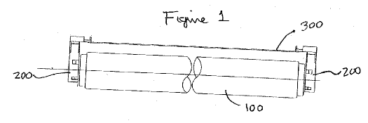

FIG. 1 is a side view of a mounting profile of a fluorescent lamp fixture 10. The lamp 10 includes a fluorescent bulb 100 secured between two sockets 200 that are mounted to a mounting plate 300 defined by the fluorescent fixture 10.

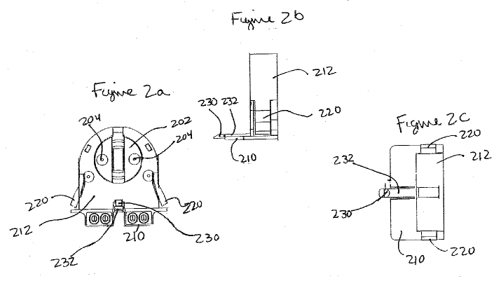

FIGS. 2a through 2c show the socket 200 from the front (FIG. 2a), the side (FIG. 2b) and the top (FIG. 2c). The socket 200 includes a receiving region 202 that is designed to receive the end of the bulb 100. The receiving region 202 includes contact receptacles 204 and may permit the bulb 100 to be rotated and locked into position (such is well known in the art). The socket 200 also includes a base 210 that supports the receiving region 202 and that receives wires or electrical current from the lighting fixture to connect or flow to the contact receptacles 204.

The socket 200 has a pair of flexible wings 220 that protrude from the body 212 thereof and a nib 230 that extends outwardly from the body 212 along a flexible arm 232.

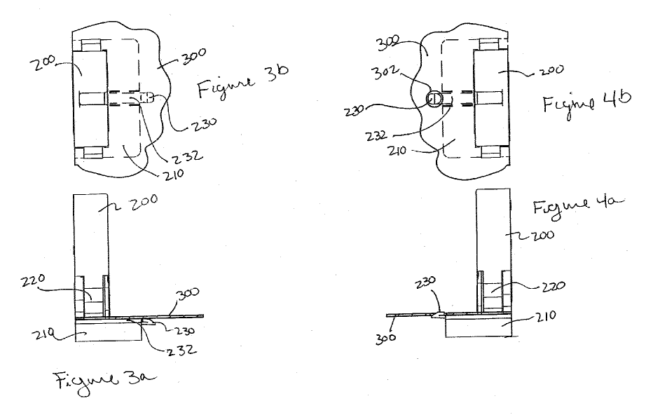

Referring now to FIGS. 3a and 3b, when the socket 200 is mounted to the mounting plate 300 the wings 220 on the socket 200 are positioned on one side the plate 300 while the flexible arm 232 and the nib 230 are positioned on the opposite or bottom side of the plate 300 thereby creating a frictional attachment. The flexible arm 232 bends downwardly away from the plate 300 allowing the socket 200 to be attached at a straight angle. This is particularly true when the plate 300 does not includes an aperture to receive the nib 230.

Referring now to FIGS. 4a and 4b, the plate 300 includes an aperture 302 which receives the nib 230 allowing the socket to be held in place without the ability to accidentally be removed. To remove the socket 200, the user presses the nib 230 out of the aperture 302 and slides the socket 200 away therefrom.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred.

1. A fluorescent-lamp socket for use with a mounting plate defined by a lighting fixture, where the mounting plate may be used to secure said lighting fixture to a surface, the socket comprising: a region to receive an end of the fluorescent lamp; a base extending outwardly from the receiving region to support the mounting plate, the base having a removed section; a flexible arm extending outwardly from the receiving region and being positioned in said removed section of said base; and a nib extending upwardly from an end of said flexible arm.

2. The socket of claim 1, wherein the nib is received in an aperture defined by the mounting plate, such that the socket is removeably secured to the mounting plate.

3. The socket of claim 1, wherein the nib frictionally engages a bottom portion defined by the mounting plate, such that the socket is frictionally secured to the mounting plate.

4. A fluorescent-lamp socket comprising: a fluorescent lamp end receiving region; a mounting plate support region extending outwardly from the fluorescent lamp end receiving region; a flexible arm defined on the mounting plate support region; and a nib extending upwardly from an end of said flexible arm.

5. The socket of claim 4, wherein the flexible arm is substantially rigid such that when the socket is being secured to a mounting plate, the nib frictionally engages the mounting plate.

6. The socket of claim 5, wherein the nib has a shape to engage an opening defined on the mounting plate such that the nib when positioned in said opening secures the socket to said mounting plate.
